(19) United States
(12) Patent Application Publication
(10) Pub. No.: US 2013/0151346 A1
(43) Pub. Date: Jun. 13, 2013

(54) REDACTING PORTIONS OF ADVERTISEMENTS DELIVERED TO UNDERAGE USERS

(71) Applicant: Kent Schoen, San Francisco, CA (US)

(72) Inventor: Kent Schoen, San Francisco, CA (US)

(21) Appl. No.: 13/316,149

(22) Filed: Dec. 9, 2011

(51) Int. Cl. G06Q 30/02

(52) U.S. Cl. 705/14.66

(57) ABSTRACT

An advertising system provides online advertisements to users of an online system, where portions of the advertisements are redacted if served to users who are underage. The system includes a data store, which stores advertisements that have a plurality of components. When a user is to be served an advertisement, the system determines the user's age, and then redacts portions of the advertisement that the user is not old enough to view.

### BACKGROUND

This invention relates generally to social networking, and in particular to providing redacted advertisements, to users of a social networking system.

Some online advertisements are not appropriate to display to users of all ages. For example, advertisements for alcohol or violent movies may contain content that is inappropriate for users under a certain age. Current ad systems may prevent an advertisement with potentially inappropriate content from being displayed but lack the ability to redact portions of an advertisement to make the advertisement suitable for display. Consequently, an advertisement that contains some material that is inappropriate for underage users cannot deliver its message to those users, even aspects of the message that may be appropriate for them.

### SUMMARY

Systems and methods are disclosed herein for providing online advertisements to users of an online system, where portions of the advertisements are redacted if served to users who are underage. These methods and systems help advertisers increase the number of users that an advertisement can be display to and help online systems protect users from viewing age inappropriate content.

In one embodiment, advertisements having one or more components are stored in a data store. A viewing user of an online system to receive an advertisement is identified and an advertisement from the data store is selected to display to the viewing user. The age of the viewing user is determined and one or more components of the selected advertisement are redacted based on the determined age of the viewing user.

### BRIEF DESCRIPTION OF THE DRAWINGS

FIG. 1 is a high level block diagram illustrating a system environment suitable for redacting portions of advertisements, in accordance with one embodiment of the invention.

FIG. 2 is a high level block diagram illustrating a system environment suitable for redacting portions of advertisements, in accordance with one embodiment of the invention.

FIG. 3 is a flow chart illustrating a process for redacting portions of advertisements, in accordance with an embodiment of the invention.

FIG. 4A is a screenshot of a first advertisement and a redacted version of the first advertisement, in accordance with an embodiment of the invention.

FIG. 4B is a screenshot of a second advertisement and a redacted version of the second advertisement, in accordance with an embodiment of invention.

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

### DETAILED DESCRIPTION

### Overview of Advertisement Redaction Flow

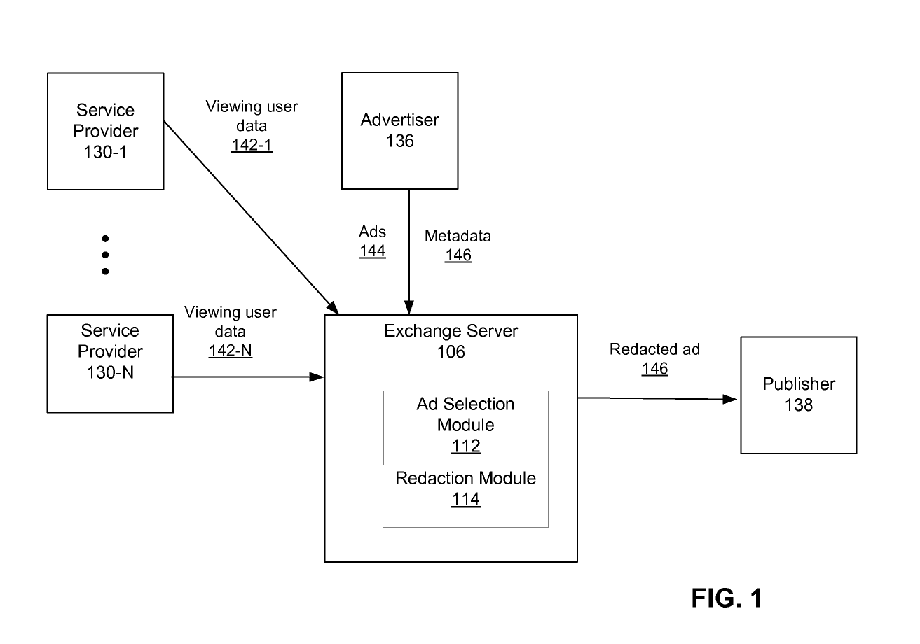

FIG. 1 is a diagram of a process for redacting portions of advertisements, in accordance with one embodiment of the invention. In one embodiment, one or more service providers 130 send user data 142 to an exchange server 106. The advertiser 136 sends advertisements 144 and/or metadata 146 for the advertisements 144 to the exchange server 106. An ad selection module 112 selects an advertisement (“ad”) to display to a user of an online system. A redaction module 114 redacts portions of the selected advertisement based on the user's age. The exchange server 106 sends a redacted advertisement 146 to the publisher 138 which sends the redacted advertisement 146 to a user.

A service provider 130 includes any entity that provides data or an online service to a user over a network, including but not limited to social networking systems, web retailers, news providers, video content item providers, etc. The embodiments disclosure herein may include one or more service providers 130. The exchange server 106 may be a service provider, a social networking system, or another entity.

The user data 142 provided by the service providers 130 may include any information associated with a user. For example, the user data 142 may include but is not limited to a user's declared profile information, browsing history, purchasing history, content item viewing history, and social networking system information.

An advertiser 136 is an entity that provides advertisements 144 to display to users. An advertisement may include one or more components, which may include one or more of a selectable link, an image, a video, an animation, text, and a social endorsement. The selectable link may link to an object that is outside or inside the domain of the online system. The advertisements may include any combination and number of components. For example, an advertisement may include multiple links, images, video, and animations. In some embodiments, the advertiser 136 provides the exchange server 106 with multiple versions of an advertisement, where each version is directed to a certain age group. For example, an advertiser may provide a version of an advertisement that is appropriate for users of all ages and a second version of the ad that is appropriate for users 21 years or older. Each version of the advertisement includes metadata that specifies the threshold age for the audience of the advertisement as well as version information.

In one embodiment, the advertiser 136 provides advertisements 144 with metadata 146 to the exchange server 106. In some embodiments, the metadata 146 may include targeting criteria for an advertisement. The targeting criteria may include age, gender, income, geographic location, education, religion, race, marital status, household size, employment status, and political party affiliation. For example, the metadata 146 may provide that a viewing user should be thirty years old with a university degree.

In some embodiments, the metadata 146 specifies a threshold age for an advertisement as a whole or threshold ages for each component of the advertisement. A threshold age for a component of an advertisement specifies the minimum age a user has to be in order to view the component of the advertisement. When a user is not old enough to meet a threshold age for an advertisement, the user is underage and it is not appropriate to display the advertisement to the user. Multiple threshold ages may be associated with an advertisement. For example, an advertisement containing an image and text may include a first threshold age requirement for the image and a second threshold age for the text. Advertisers may define and associate the threshold ages to an advertisement in order to prevent the advertisement or a portion of the advertisement from being viewed by an underage user. By attaching one or more threshold ages to an advertisement, advertisers can display redacted advertisements to users when the user is not old enough to review the full version of the advertisement. This allows advertisers to advertise to wider range of users while protecting themselves from complaints from user's parents.

In some embodiments, the metadata 146 describes the subject matter of an ad, the subject matter of one or more components of the ad, the product or service represented by the ad or any other characteristic, feature, or property of the ad. For example, the metadata 146 for an advertisement may indicate that the advertisement is about alcohol or a movie with violent content.

In one embodiment, the ad selection module 112 selects an advertisement for a viewing user where the user data 142 for the viewing user meets the advertisement's targeting criteria. In other embodiments, the ad selection module 112 may select an advertisement based on other metrics, including but not limited to, the expected revenue from displaying the a advertisement to the viewing user, the click-through rate (CTR), the likelihood that the viewing user will visit a web page associated with the displayed advertisement, and the likelihood that the viewing user will purchase an item shown in the displayed advertisement. In another embodiment, the ad selection module 112 may receive bids from advertisers to select a particular advertisement to display to users. For example, if two or more advertisements' targeting criteria match a user, the ad selection module 112 may allow advertisers to place bids for displaying the advertisement to a user. In such an instance, the ad selection module 112 receives bids and selects the matching advertisement that has the highest bid associated with displaying the advertisement to the user.

The redaction module 114 redacts portions of an advertisement that are inappropriate for an underage user to view. More specially, the redaction module 114 redacts one or more components of an advertisement based on the age of the viewing user. The redaction module 114 may modify portions of an advertisement or select a version of the advertisement that is appropriate for the viewing user. In some embodiments, the reaction module 116 removes a selectable link, an image, a video, an animation, text, social endorsement, or any combination thereof. A redacted component is obscured or removed from the advertisement such that the redacted component is not visible to a user or is no longer functional.

A publisher 138 is an entity that displays an advertisement to a user. A publisher 138 may include, for example, a service provider 130 such as a newspaper, a video content provider, a web retailer, an email service provider, or a social networking system. In one embodiment, the publisher 138 receives a redacted advertisement 146 provided by the exchange server 106 and sends the redacted advertisement 146 to a user for display.

These embodiments describing redacting portions of advertisements are merely meant to be exemplary, and are not intended to be restrictive. In other embodiments, there are more or fewer components performing the same or substantially similar functions as the components of the embodiment of FIG. 1. In addition, as will be discussed below, in some embodiments, the functionality of the ad selection module 112 and redaction module 114 may be provided by the exchange server 106; in other embodiments, all or part of this functionality may be provided external to the exchange server 106.

### Advertising System Overview

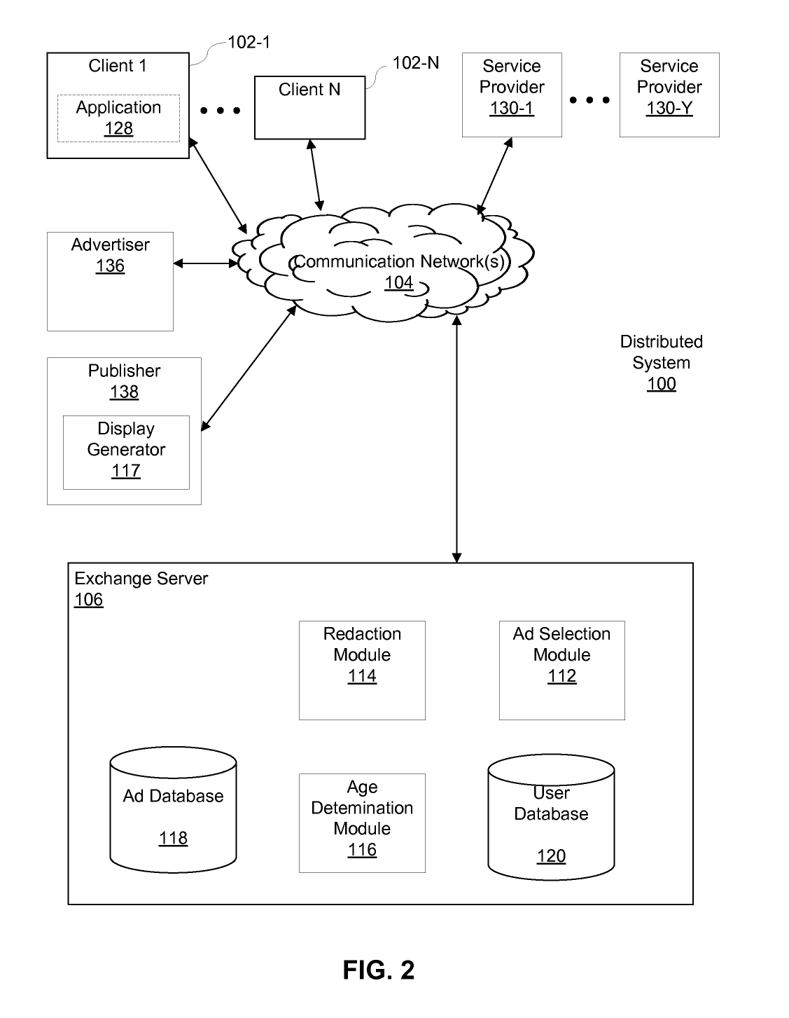

FIG. 2 is a high level block diagram of a distributed system 100 of an online system according to one embodiment of the invention. The distributed system 100 includes one or more clients 102, an advertiser 136, one or more service providers 130, a publisher 138 and an exchange server 106 connected by a network 104. In some embodiments, the server system 106 is implemented as a single server, while in other embodiments it is implemented as a distributed system of multiple servers. For convenience of explanation, the exchange server 106 is described below as being implemented on a single server system, but the exchange server 106 may be implemented on a plurality of server computers. Additionally, the advertiser 136, service provider 130 and publisher 138 may each be implemented on a plurality of server computers.

The communication network(s) 104 can be any wired or wireless local area network (LAN) and/or wide area network (WAN), such as an intranet, an extranet, or the Internet. It is sufficient that the communication network 104 provides communication capability between the client devices 102 and the server system 106. In some embodiments, the communication network 104 uses the HyperText Transport Protocol (HTTP) and the Transmission Control Protocol/Internet Protocol (TCP/IP) to transmit information between devices or systems. HTTP permits client device 102 to access various resources available via the communication network 104. The various embodiments of the invention, however, are not limited to the use of any particular protocol.

A user interacts with the server system 106 using a client device 102, which may be any suitable computer device that is capable of connecting to the server system 106 via communication network 104, such as a computer, a desktop computer, a laptop computer, a tablet device, a netbook, an internet kiosk, a personal digital assistants, a mobile phone and a gaming device. The client device 102 may communicate with the server system 106 via an application 128 such as a web browser or native application. Typical interactions between the client device 102 and the server system 106 include operations such as viewing profiles of other users of the server system 106, sending messages to other users, contributing and interacting with media items, joining groups, listing and confirming attendance at events, checking in at locations, liking certain pages, creating pages, and performing other tasks that facilitate social interaction.

The ad database 118 stores advertisements. In one embodiment, an ad is a web-based ad that is displayed in the margins or other dedicated area of a website. In another embodiment, an ad is displayed within a software application, a video game, or a mobile device application. As described above, the advertisements may include one or more components and metadata. The ad database 118 may store several versions of an advertisement. In some embodiments, the ad database 118 resides on the advertiser's server 136.

The user database 120 may store user data such as biographic, demographic and other types of descriptive information (birthday, age, work experience, gender, educational history, hobbies or preferences, interests, geographic location, marital status, household size, political party and the like). The user data may include a list of user identifiers that correspond to a user's connections or friends in the online system. The user data may also indicate a user's family members. For example, the user data may include information identifying a user's brothers, sisters and parents.

The ad selection module 112 identifies a viewing user and selects an advertisement for the viewing user. The viewing user may be identified by a user identifier that correlates to the user profile for the viewing user. The user identifier may be received in requests for pages of the online system. For example, when a viewing user requests a profile page, the request for the profile page includes the viewing user's identifier. The user identifier may also be looked up from the user database 118 when the viewing user logs onto the online system. The user identifier may be received by the ad selection module 112 and may be received in response to the viewing user opening a native application, logging onto the online system, visiting a third party website, or requesting a page of the social networking system.

The age determination module 116 determines the age of a viewing user. The age determination module 114 may determine or infer the viewing user's age from the user's information stored in the user database 120. For example, the age determination module 116 may retrieve the user's birthday from the user's profile information or account information. The age determination module 116 may infer a viewing user's age from the viewing user's actions or from actions of the viewing user's connections. Techniques for inferring a user's age based on social information are described further in U.S. application Ser. No. 12/916,322, filed Oct. 29, 2010, entitled “Inferring User Profile Attributes From Social Information,” the content of which is incorporated by reference herein in its entirety.

The redaction module 114 removes content from advertisements that is inappropriate for underage users. More specially, the redaction module 114 redacts one or more components of an advertisement based on a viewing user's age. The redaction module 114 obtains the viewing user's age from the age determination module 114. One or more components of an advertisement may be selected for redaction based on polices set by the operator of the online system and/or on age thresholds set by an advertiser. The policies may include content policies that specify threshold ages for categories of content or specific content. The policies may also includes component polices that specify threshold ages for different types components of an advertisement.

In some embodiments, the redaction module 114 stores content policies specifying threshold ages for different categories of content. For example, a content policy may specify that components of an advertisement that have content relating to alcohol should not be shown to users under the age of 21. Some possible categories of content include alcohol, sexually explicit material, inappropriate language, violence and illegal behavior. In one embodiment, the redaction module 114 redacts one or more components of an advertisement based on the viewing user's age, the threshold ages specified in a content policy and metadata associated with the advertisement that indicates the subject matter of the advertisement. For example, in one embodiment, the redaction module 114 determines the subject matter of the components of an advertisement based on the metadata for the advertisement, compares the viewing user's age to the threshold ages in the content policy that correspond to the subject matter of the components of the advertisement and redacts one or more components of the advertisement based on the comparison.

In some embodiments, the redaction module 114 stores a content policy that specifies threshold ages for specific content. More specially, the content policy may specify threshold ages for dictionaries of words or phrases. For example, the content policy stored in the redaction module 114 may specify that a viewing user must be 21 years or older to view words from a profanity dictionary. The dictionaries are stored in the redaction module 114 and associated with one or more policies. In some embodiments, the redaction module 114 compares the viewing user's age against the threshold ages of one or more dictionaries of words or phrases and determines which dictionaries that the viewing user cannot view. If there are dictionaries of words and phrases that the viewing user is not old enough to view, the redaction module 114 determines whether any words or phrases from those dictionaries are present in the advertisement and redacts the words and phrases from the advertisement. In some embodiments, when the advertisement includes a link, the redaction module 114 downloads the page associated with the link, scans the page for the existence of words or phrases from a dictionary and redacts the link of the page has words and/or phrases that the user is not old enough to view.

In some embodiments, the redaction module 114 stores different policies for different geographic regions. For example, the redaction module 114 may store a set of content policies for the United States and another set of content policies for Europe. Different geographic regions may have different rules about different categories of content. For example, countries often differ on the legal drinking age and on the appropriate age to view violent content. In one embodiment, the redaction module 114 determines the type of content of one or more components of an advertisement based on the metadata associated with the advertisement, identifies the geographic specific policy based on the viewing user's geographic location, compares the viewing user's age to the threshold ages specified in the geographic specific policy and redacts one or more components of the advertisement based on the comparison.

In some embodiments, the redaction module 114 includes a component policy that specifies threshold ages for types of advertisement components. For example, users under the age of 18 may not be allowed to view advertisements that include links to third party websites. In one embodiment, the redaction module 114 compares the viewing user's age with the component policy to determine inappropriate advertisement components that the viewing user is not old enough to view, determines the type of components in an advertisement and redacts any inappropriate components in the advertisement.

In some embodiments, the redaction module 114 includes a component policy that specifies a threshold age for viewing social endorsements in advertisements. A social endorsement or social ad comprises an advertising message that communicates a message about at least one user action. A social ad, for example, may inform a user that a friend (or a number of friends) of the user has purchased a particular item made by an advertiser, will attend an event sponsored by an advertiser, or has added a connection to a profile for a business or other entity. Other examples of actions that may be described in a social ad may include checking in at a location, purchasing a product or service, joining a group, attending an event, using a third party application, playing a game, or expressing an affinity towards an object in the online system. In some embodiments, a social ad communicates a message about the actions of some number of friends of a user. For example, a user may receive a message like “Three of your friends have joined the “Yale Alumni Network.” In some embodiments, a social ad includes an indication that a friend of the viewing user approves of a product or service associated with the ad or has otherwise interacted with an object associated therewith. For example, a social ad may include a testimonial from a friend or an indication that the friend is a fan of a product.

In one embodiment, the component policy includes a family member rule that limits the display of social endorsements to family members. In one embodiment, the component policy includes an age limit rule that specifies that a viewing user may only view social endorsements from users of the same age as the viewing user. The redaction module 114 may apply the family member rule or the age limit rule or both. In one embodiment, the redaction module 114 determines whether an advertisement includes a social endorsement, identifies a user of the social endorsement, determines using the viewing user's information whether the user is a member of the viewing user's family and redacts the social endorsement if the user is not a member of the viewing user's family. Redacting social endorsements may beneficially prevent older users from inappropriately influencing younger users. For example, a beer advertisement endorsed by users older than the legal drinking age may inappropriately influence children younger than the legal drinking age.

In one embodiment, where the redaction module 114 has redacted the social endorsement from the advertisement, the redaction module 114 may determine a new social endorsement for the advertisement that is from the viewing user's family or from a user that is the same age as the viewing user. In one embodiment, the redaction module 114 identifies family members of the viewing user and/or users of the same as the viewing user from the user database 120, determines actions of the family members or other users of the same age that relate to an advertisement to create a new social endorsement and inserts the new social endorsement into the advertisement.

In some embodiments, the redaction module 114 redacts one or components of an advertisement based a viewing user's age and one or threshold ages assigned to one or more components of the advertisement. An advertiser may assign a threshold age to each component of an advertisement in order to control the audience of each component of the advertisement. For example, an advertisement may include a first age threshold for the text component of the advertisement and a second threshold age for the image component of the advertisement. The threshold ages for the components of an advertisement may be stored in the advertisement's metadata. In one embodiment, the redaction module 114 determines the threshold ages for an advertisement, compares the viewing user's age to the threshold ages and redacts one or more components of the advertisement based on the comparison.

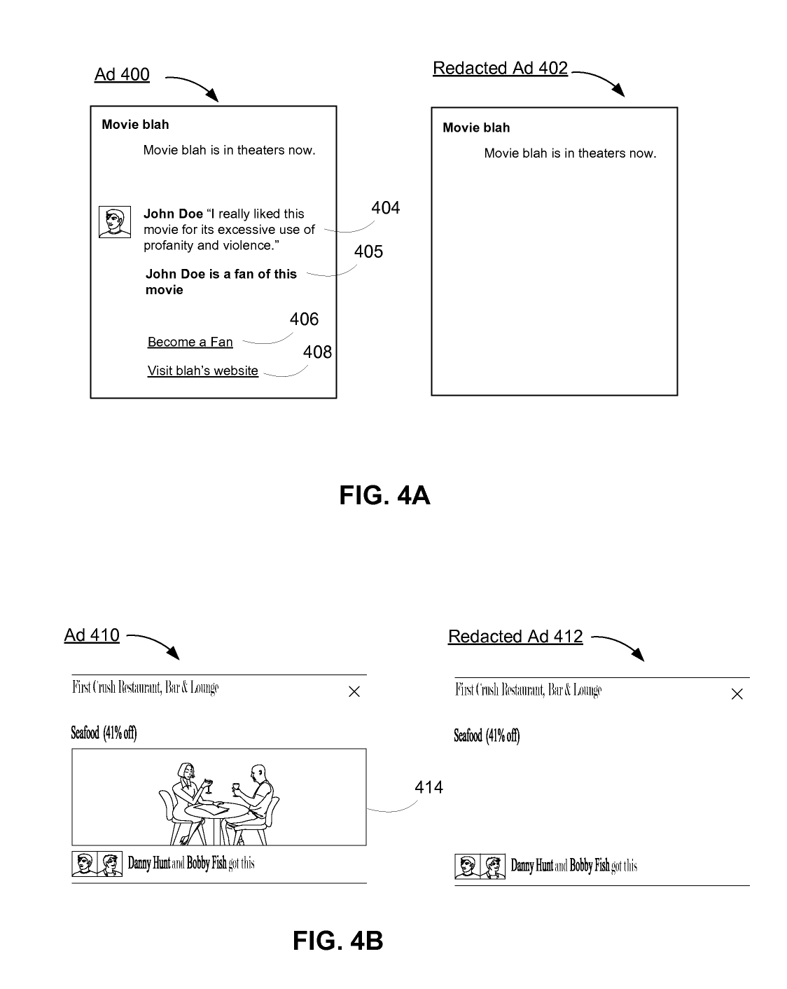

The redaction module 114 may modify the advertisement in order to obscure or remove one or more components of the advertisement. In some embodiments, the redaction module 114 redacts a social endorsement from an advertisement. For example, FIG. 4A illustrates an ad 402 that is a redacted version of ad 400. In this example, two social endorsements (i.e., 404 and 405) from John Doe have been redacted from ad 400.

In some embodiments, the redaction module 114 redacts one or more links from an advertisement. The links may be embedded into an image, displayed in an image or displayed in the text of the advertisement as a selectable link. In the example of FIG. 4A, the “visit blah's website” link 408 has been redacted from ad 400. In some embodiments, the anchor text of the link is not redacted, but the functionality of the link is disabled. In other words, the anchor text of the link is displayed but a user cannot select the link.

In some embodiments, the redaction module 114 redacts inappropriate words or phrases from an advertisement. The redaction module 114 may modify the advertisement in order remove or obscure the inappropriate words or phrases in the advertisement. In some embodiments, when the words or phrases are embedded in an image, the redaction module 114 may modify a portion of the image or remove the image.

In some embodiments, the redaction module 114 redacts one or more images, videos, and animations from an advertisement. FIG. 4B illustrates an ad 412 that is a redacted version of the ad 410. In this example, an image 414 has been redacted from ad 410.

In some embodiments, the redaction module 114 selects a version of an advertisement to send to a viewing user. As described above, an advertiser may supply the exchange server 106 with several different versions of an advertisement, where each version is directed to a certain age group. For example, a first version of the advertisement may be appropriate for people of all ages and a second version of the advertisement may only be appropriate for users ages 18 and over. In one embodiment, the redaction module 114 compares the age of viewing user to the metadata associated with each version of the advertisement and selects a version of the advertisement that the viewing user is old enough to view.

The display generator 117 prepares and sends the redacted advertisement to display to a viewing user. The display generator 117 may send the redacted advertisement to a native application, a third party website or web page of the online system.

### Redacting Portions of Advertisements Delivered to Underage Users

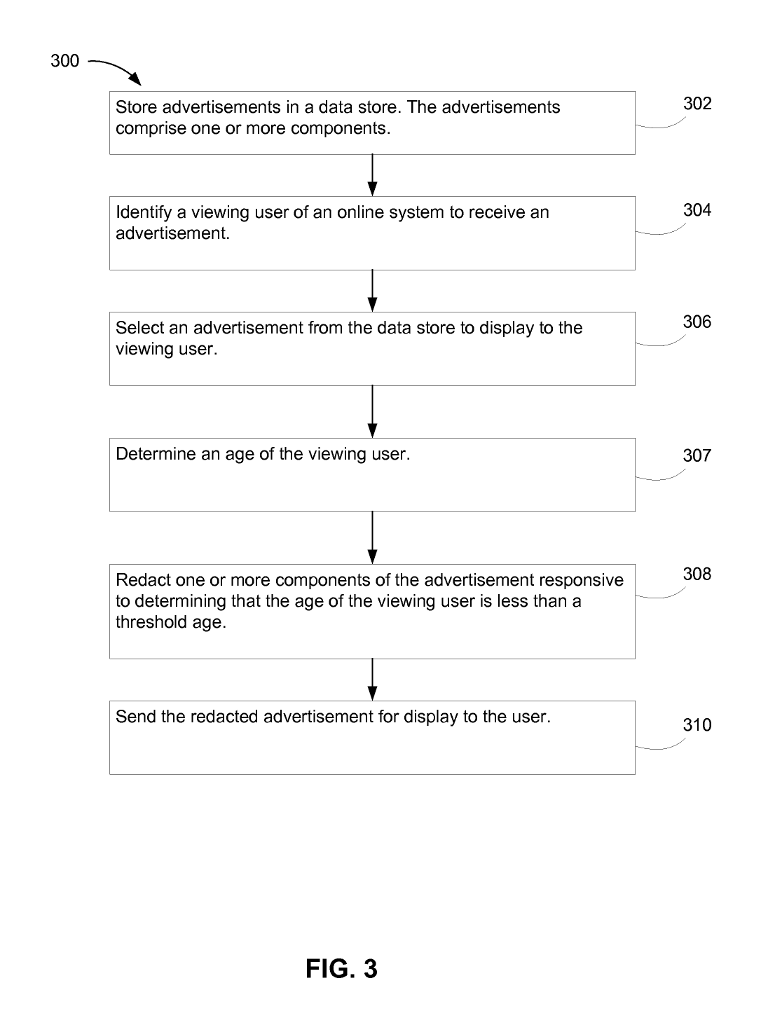

FIG. 3 is a flow chart of a process 300 for redacting portions of advertisements, in accordance with one embodiment of the invention. This process 300 helps advertisers increase the number of users that an advertisement can be display to and helps social networking systems protect users from viewing inappropriate content. The process 300 is performed at a server system (e.g., server system 106) having one or more processors and non-transitory memory. The non-transitory memory stores one or more programs to be executed by the one or more processors. The one or more programs include instructions for process 300.

Advertisements to display to users are stored 302 in a data store. For example, the advertisements are stored in the ad database 118. The advertisements comprise 302 one or more components. The one or more components comprise at least one of a selectable link, an image, a video, an animation, text, and a social endorsement.

A viewing user of an online system to receive an advertisement is identified 304. The viewing user may be identified by the ad selection module 112 when the viewing user logs onto the online system or requests a page of the online system. The ad selection module 112 selects an advertisement 306 from the data store to display to the viewing user. As described above, the ad selection module 112 selects an advertisement for a user based on the user's information and on targeting information associated with the advertisements.

Before the selected advertisement is displayed to the viewing user, the redaction module 114 determines whether any portion of the advertisement should be redacted. The age module 116 determines 307 the age of the viewing user. The redaction module 114 redacts 308 one or more components of the advertisement responsive to determining that the age of the viewing user is less than a threshold age to produce a redacted advertisement. The threshold age may be defined by a policy stored in the redaction module 114 or defined in the metadata for the selected advertisement. In some embodiments, the advertisement includes a plurality of components and a plurality of threshold ages for the plurality of components. In this case, a respective component of the advertisement is redacted if the viewing user's age does not meet the age threshold for the respective component. For example, for an advertisement with three components, the redaction module 114 determines a threshold age for each of the three components, determines whether the viewing user's age meets the threshold age for each of the components and redacts the components that the viewing user is not old enough to view.

A redacted component is obscured or removed from the advertisement such that the redacted component is not visible to a user or not functional. However, a redacted advertisement still contains some content from the original, un-redacted version of the advertisement. By redacting portions of an advertisement, advertisers are able to increase the number of users that the advertisement can be displayed to and social networking systems are better able to protect users from viewing inappropriate content.

After content that is inappropriate for the viewing user's age has been redacted from the advertisement, the redacted advertisement is then sent 310 to the viewing user for display. The display generator 117 may send the redacted advertisement to a native application, a third party website or a page of the online system.

### Summary

The foregoing description of the embodiments of the invention has been presented for the purpose of illustration; it is not intended to be exhaustive or to limit the systems and methods to the precise forms disclosed. Persons skilled in the relevant art can appreciate that many modifications and variations are possible in light of the above disclosure.

Some portions of this description describe the embodiments of the systems and methods in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the systems and methods may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the systems and methods may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the systems and methods systems and methods be limited not by this detailed description, but rather by any claims that issue on an application based hereon. Accordingly, the disclosure of the embodiments of the systems and methods are intended to be illustrative, but not limiting, of the scope of the invention, which is set forth in the following claims.

1. A computer-implemented method comprising:
storing advertisements in a data store, the advertisements comprising one or more components;
identifying a viewing user of an online system to receive an advertisement;
selecting an advertisement from the data store to display to the viewing user;
determining an age of the viewing user;
responsive to determining that the age of the viewing user is less than a threshold age, redacting one or more components of the selected advertisement to produce a redacted advertisement; and
sending the redacted advertisement for display to the user.

2. The method of claim 1, wherein the components of advertisement include at least one of a selectable link, an image, a video, an animation, text, and a social endorsement.

3. The method of claim 1, wherein the redacting comprises removing one or more selectable links from the advertisement.

4. The method of claim 1, wherein the redacting comprises removing one or more images from the advertisement.

5. The method of claim 1, wherein the redacting comprises removing text from the advertisement.

6. The method of claim 1, wherein the redacting comprises removing a social endorsement from the advertisement.

7. The method of claim 6, wherein the redacting is further responsive to determining that the social endorsement is from another user other than a family member of the viewing user.

8. The method of claim 6, wherein the redacting is further responsive to determining that the social endorsement is from another user who is above the threshold age.

9. The method of claim 6, further comprising:
selecting a new social endorsement from another user who is a family member of the viewing user and is within the threshold age; and
inserting the new social endorsement into the advertisement.

10. The method of claim 1, wherein the age of the viewing user is determined based on inferred actions of one or more connections of the viewing user.

11. The method of claim 1, wherein the redacted advertisement is sent to a native application running on a device associated with the viewing user.

12. The method of claim 1, wherein the redacted advertisement is sent to a browser application running on a device associated with the viewing user.

13. A non-transitory computer readable storage medium storing one or more programs, the one or more programs comprising instructions, which when executed by a server system, cause the server system to:
store advertisements in a data store, the advertisements comprising one or more components;
identify a viewing user of an online system to receive an advertisement;
select an advertisement from the data store to display to the viewing user;
determine an age of the viewing user;
responsive to determining that the age of the viewing user is less than a threshold age, redact one or more components of the selected advertisement to produce a redacted advertisement; and
send the redacted advertisement for display to the user.

14. A computer-implemented method comprising:
storing advertisements in a data store, the advertisements comprising one or more components;
identifying a viewing user of an online system to receive an advertisement;
selecting an advertisement from the data store to display to the viewing user;
determining an age of the viewing user;
responsive to determining that the age of the viewing user is less than a threshold age, modifying one or more components of the selected advertisement to produce a modified advertisement; and
sending the modified advertisement for display to the user.

15. A computer-implemented method comprising:
storing advertisements in a data store, the advertisements comprising one or more components;
identifying a viewing user of an online system to receive an advertisement;
selecting an advertisement from the data store to display to the viewing user;
redacting inappropriate content from the selected advertisement based on an age of the viewing user to produce a redacted advertisement;
sending the redacted advertisement for display to the user.

16. A computer-implemented method comprising:
storing advertisements in a data store, the advertisements comprising one or more components;
identifying a viewing user of an online system to receive an advertisement;
selecting an advertisement from the data store to display to the viewing user, the selected advertisement including a plurality of components and threshold ages for the plurality of components;
determining an age of the viewing user;
responsive to determining that the page of the viewing user is less than a threshold age for a respective component of the selected advertisement, redacting the respective component from the selected advertisement to produce a redacted advertisement; and
sending the redacted advertisement for display to the user.
